(19) United States
(12) Patent Application Publication
(10) Pub. No.: US 2014/0116196 A1
(43) Pub. Date: May 1, 2014

(54) Flared Grip for Bicycle or Motorcycle Handlebar

(71) Applicant: Derrick Gary Rogers, South Lake Tahoe, CA (US)

(72) Inventor: Derrick Gary Rogers, South Lake Tahoe, CA (US)

(21) Appl. No.: 13/961,657

(22) Filed: Aug. 7, 2013

Related U.S. Application Data
(60) Provisional application No. 61/795,887, filed on Oct. 31, 2012.

(51) Int. Cl. B62K 21/26

(52) U.S. Cl. CPC B62K 21/26
USPC 74/551.9

(57) ABSTRACT

A flared or bell shaped motorcycle/bicycle handgrip which improves the design of handgrips, more specifically handgrips for mountain bike type bicycles and motorcycles with clip-on handlebars. Clip-ons are comprised of two separate short handles which are attached directly to the fork tubes, are placed lower than conventional handlebars, and are angled downward creating a lot of pressure on the wrists while riding. In order to alleviate wrist strain, and improve throttle control and steering inputs, the body of the present invention has an external surface which is flared. This flare spreads out the pressure and provides a larger surface for the palm to rest upon, and a larger surface area to grab onto, providing a more secure grip for mountain bikers. The flare is achieved by the base area progressively increasing in diameter, radially, the last half of the grip adjacent the second end, which is flat.

### CROSS REFERENCE TO RELATED APPLICATION

This application claims the benefit of U.S. Provisional Application No. 61/795,887, filed Oct. 31, 2012, the contents of which are incorporated herein by reference.

### BACKGROUND OF THE INVENTION

The present invention relates generally to bicycle or motorcycle handgrips and more specifically to a flared or bell shaped handgrip that offers features that are of benefit to riders of mountain bike type bicycles and supersport type motorcycles with clip-on style handlebars.

The majority of conventional grips today are comprised of a hollow cylindrical body of flexible resilient material, such as rubber (natural or synthetic), having a first, open end, an opposing second end, which is also open, an annular flange projecting radially outwards at the first open end, and a constant diameter outer surface usually with a layer of projections or grooves to reduce slippage.

Respective grips are fitted snugly (usually glued) onto each end of a handlebar, one for the left side and one for the right side. On motorcycles the right grip will have a slightly larger inside diameter in order to fit over the throttle tube.

No prior art can be found which addresses the issues of motorcycles with clip-on handlebars or mountain bikes which can jump 50 feet or more. Some prior patents claim to improve throttle control and have an ergonomic grip, as in U.S. Pat. No. 2005/0039565 A1 and U.S. Pat No. 4,031,775, some claim to be safety grips, as in U.S. Pat. No. 5,507,202, and some claim to improve grip, as in U.S. Pat. No. 4,895,044.

While these conventional devices may be suitable for the particular purpose to which they address, it has been observed that these and other conventional handgrips tend to not provide the utility necessary given the extreme downward angle of clip-on style handlebars commonly found on modern day sportbikes, and thereby give the rider mediocre throttle control, limit steering inputs, and also strain his/her wrists.

It has also been observed that conventional handgrips do not provide the grip or control necessary when negotiating a 50 foot jump or a steep single track trail on a mountain bike, which the flared handgrip does.

### BRIEF SUMMARY OF THE INVENTION

An object of the invention is to provide the motorcycle rider, and more specifically the rider of modern motorcycles with clip-on handlebars, improved throttle control. Clip-ons are comprised of two separate short handles which are attached directly to the fork tubes of the motorcycle, as opposed to a one-piece handlebar attached to the top of the “triple tree” or “top bridge”. These clip-on handlebars are placed much lower than conventional handlebars and are angled downward. Because of this, a lot of weight and pressure is placed upon the hands and wrists while riding, which causes wrist strain and limits throttle control, which the conventional motorcycle grip of today does not address.

A further object of the invention is to provide the motorcycle rider quicker steering inputs. Motorcycles rely on the physical phenomenon called “counter-steering” to steer. The conventional motorcycle grip does not address the issue of counter-steering. Counter-steering is the technique used by motorcyclists to initiate a turn toward a given direction by momentarily pushing on the clip-on/grip in the opposite direction or counter to the direction desired. It is often boiled down to “push left to go left”. To negotiate a turn successfully, the combined center of mass of the rider and motorcycle must first be leaned in the direction of the turn, and steering briefly in the opposite direction, or rather pushing on the clip-on in the opposite direction causes that lean. With the higher speeds and greater lean angles of modern sportbikes the technique of counter-steering is more important than ever before.

A further object is to provide reference for the bicycle/motorcycle rider when grasping back onto the grip while keeping his/her eyes on the trail/road, and to keep the motorcycle rider from falling off, given the extreme lean angles achieved by modern day sportbikes.

A further object is to provide better grip and control for mountain bike type bicycle riders given the extreme riding conditions and large jumps which modern mountain bikes may negotiate.

These objects are achieved in a handgrip having the features specified above in that the present invention has a flared or bell shape. By making ½ of the body gradually thicker radially, particularly making this extra thickness with a flared or bell shape, the pressure placed upon the wrists is spread out because of the increased surface area of the flared shape, and extra sensitivity is transmitted to the palms of the riders' hands providing greater control and smoother throttle operation. The flared shape also allows the rider to apply more force to the bars while counter-steering allowing quicker steering inputs, and faster transitions from side to side as in an “S” turn or when negotiating a “chicane” on a racetrack, which relates directly to faster lap times on the racetrack and safer riding on the street. The flared shape allows for a more ergonomic grip for mountain bikers in which they can grip the bars more securely which relates to greater control during fast descents and greater sensitivity for superior control while jumping through the air.

### BRIEF DESCRIPTION OF THE SEVERAL VIEWS OF THE DRAWINGS

The invention will be described further, by way of example, with reference to the drawings, in which:

FIG. 1 is a side elevation of a preferred practical embodiment of the hand grip of the invention;

FIG. 2 is a perspective view of the same hand grip;

FIG. 3 is another perspective view but from a different angle than FIG. 2

### DETAILED DESCRIPTION OF THE INVENTION

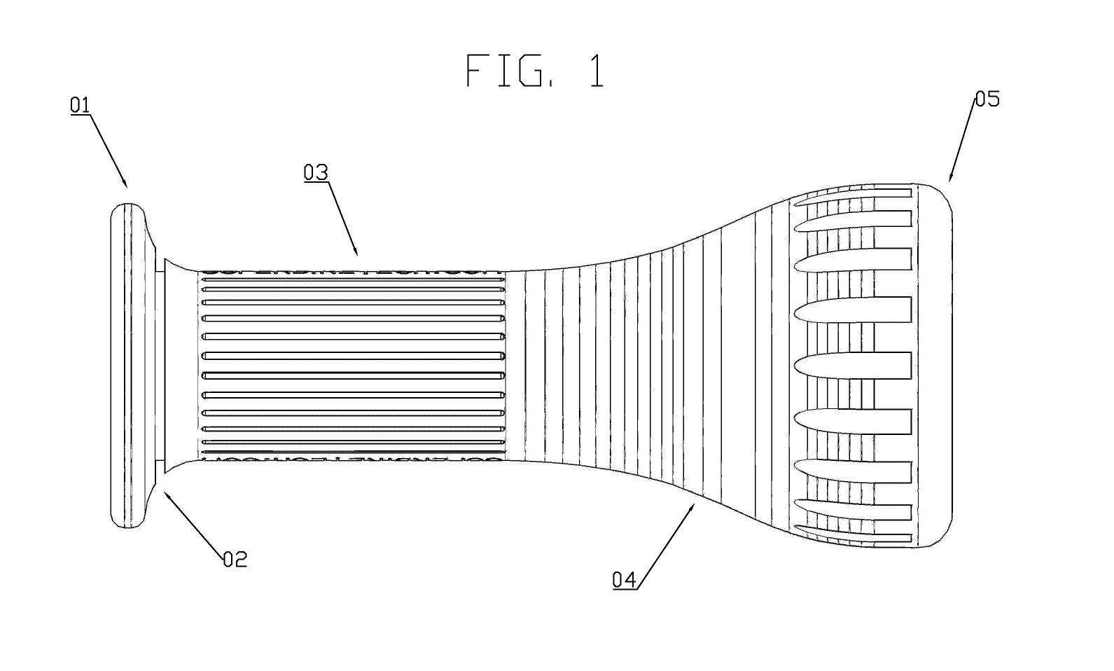

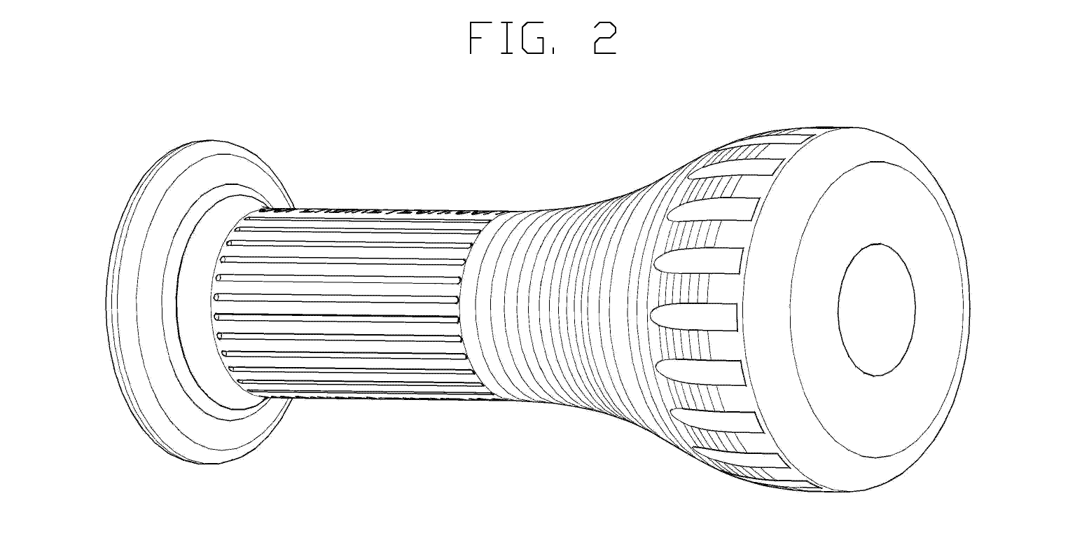

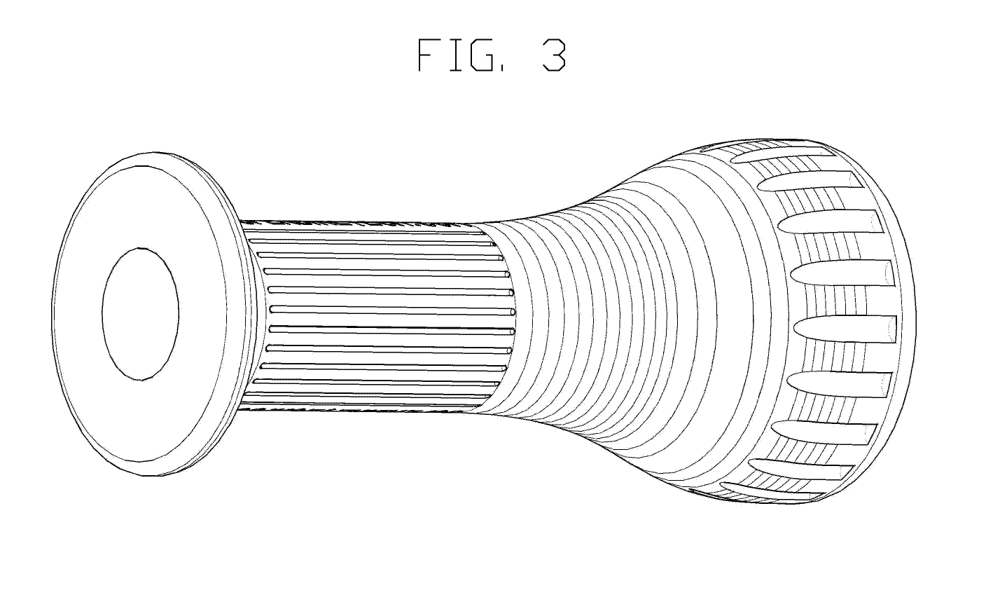

The hand grip illustrated in FIGS. 1 to 3 has a hollow cylindrical body with a first open end from which an annular flange 01 projects radially outwards, a safety wire groove 02 adjacent the annular flange, a constant external diameter approximately ½ the length of the body 03, a flared section 04 (comprising approximately the last ½ of the body), and a second end 05, which is flat and also open. The hand grip is formed from rubber (natural or synthetic).

The use of a gradual flare achieves these advantages without making the handgrip overall too thick for effective gripping/encircling by the rider's hand, as the end of the flared region 05 is over 10 mm less in diameter than a common tennis ball.

In other embodiments of the invention, which are not illustrated, the flare may have molded into it metal weights, which act as a vibration dampener.

Also, the external projections may be of a different shape and size to the illustrated embodiment.

The invention claimed is:

1. A handgrip for use with a motorcycle, the hand grip comprising:
a hollow cylindrical body having a first, open end;
an annular flange projecting radially outwards at the first, open end;
a safety wire groove adjacent the annular flange;
and a cylindrical body having a constant diameter outer surface adjacent the safety wire groove, said surface increasing in diameter radially, approximately the last half of the body, reaching its largest diameter adjacent the second end, which is flat and also open, so as to provide an external flare to the body;

2. A hand grip as set forth in claim 1 wherein the right side grip has a slightly larger inside diameter in order to fit over the throttle tube.

3. A hand grip as set forth in claim 1, wherein the handgrip is comprised of rubber (natural or synthetic).

4. A hand grip as set forth in claim 1 wherein anti-vibration dampening weights are molded into the flared section adjacent the second end.

5. A handgrip for use with a bicycle, the hand grip comprising:
a hollow cylindrical body having a first, open end;
an annular flange projecting radially outwards at the first, open end;
a safety wire groove adjacent the annular flange;
and a cylindrical body having a constant diameter outer surface adjacent the safety wire groove, said surface increasing in diameter radially, approximately the last half of the body, reaching its largest diameter adjacent the second end, which is flat and also open, so as to provide an external flare to the body.

6. A hand grip as set forth in claim 5, wherein the handgrip is comprised of rubber (natural or synthetic).
